(19) United States
(12) Patent Application Publication
(10) Pub. No.: US 2026/0204961 A1
(43) Pub. Date: Jul. 16, 2026

(54) STATOR LAMINATED CORE, STATOR DEVICE, ASSOCIATED PRODUCTION METHOD, ELECTRIC MACHINE FOR AN ELECTRICALLY DRIVABLE VEHICLE, AND ELECTRICALLY DRIVABLE VEHICLE

(71) Applicant: VALEO EAUTOMOTIVE GERMANY GMBH, Erlangen (DE)

(72) Inventors: Benedikt NOE, Bad Neustadt a.d.Saale (DE); Philipp SÖNTGERATH, Bad Neustadt a.d.Saale (DE)

(73) Assignee: VALEO EAUTOMOTIVE GERMANY GMBH, Erlangen (DE)

(21) Appl. No.: 19/137,901

(22) PCT Filed: Dec. 19, 2023
(86) PCT No.: PCT/EP2023/086702

§ 371 Date: Jun. 11, 2025

(30) Foreign Application Priority Data
Dec. 21, 2022 (DE) 10 2022 134 303.0

(51) Int. Cl. H02K 1/18; H02K 15/028

(52) U.S. Cl. CPC H02K 1/185; H02K 15/028

(57) ABSTRACT

Stator laminated core having a longitudinal axis, first and second end faces situated axially opposite each other, a first axial portion extending from the first end face towards the second end face, and first to fourth non-overlapping sectors distributed circumferentially in order. The stator laminated core forms a rotor receiving space, which extends along the longitudinal axis from the first to second end face, and forms multiple fastening openings distributed about the longitudinal axis at angular positions between adjacent ones of the first to fourth sectors and extend from the first end face to the second end face. Further, it has a radially outer lateral surface, which has a first outer radius along the first axial portion in the first and the third sector and has a second outer radius, which is greater than the first outer radius, along the first axial portion in the second and the fourth sector.

The present invention relates to a stator laminated core. In addition, the invention relates to a stator device, to an associated production method, to an electric machine for an electrically drivable vehicle, and to an electrically drivable vehicle.

It is known to accommodate stator laminated cores for forming a stator device in a stator housing, so that an inner lateral surface of the stator housing and an outer lateral surface of a stator laminated core face towards one another. To fasten the stator laminated core inside the stator housing, it is possible to provide fastening elements which pass axially through fastening openings in the stator laminated core. The radii of the lateral surfaces are at least partially dimensioned such that, while the stator laminated core is being inserted into the stator housing, there is a radial gap between the lateral surfaces, in order to enable the axial movability of the stator laminated core inside the stator housing.

However, such a gap makes it more difficult to arrange the stator laminated core and the stator housing as coaxially as possible on a common longitudinal axis. In particular, if these components are arranged with insufficient precision, undesired vibrations can occur during operation of an electric machine comprising the stator device.

The invention is based on the object of specifying an improved option for arranging a stator laminated core in a stator housing.

This object is achieved according to the invention by a stator laminated core having a longitudinal axis, having a first end face, having a second end face situated axially opposite the first end face, having an axial portion extending from the first end face towards the second end face, and having first to fourth non-overlapping sectors distributed circumferentially in the order of their designation, wherein the stator laminated core forms a rotor receiving space, which extends along the longitudinal axis from the first end face to the second end face, forms multiple fastening openings, which are distributed about the longitudinal axis at angular positions between two adjacent ones of the first to fourth sectors and extend from the first end face to the second end face, and has a radially outer lateral surface, which has a first outer radius along the axial portion in the first and the third sector and has a second outer radius, which is greater than the first outer radius, along the axial portion in the second and the fourth sector.

The stator laminated core according to the invention has a longitudinal axis, a first end face, a second end face, a first axial portion and first to fourth sectors. The second end face is situated opposite the first end face. The first axial portion extends from the first end face towards the second end face. The first to fourth sectors do not overlap. The first to fourth sectors are distributed circumferentially in the order of their designation. The stator laminated core forms a rotor receiving space. The rotor receiving space extends along the longitudinal axis from the first end face to the second end face. The stator laminated core also forms fastening openings. The fastening openings are distributed about the longitudinal axis. The fastening openings are at angular positions between two adjacent ones of the first to fourth sectors. The fastening openings extend from the first end face to the second end face. The stator laminated core has a radially outer lateral surface. The radially outer lateral surface has a first outer radius along the first axial portion in the first and the third sector. The radially outer lateral surface has a second outer radius along the first axial portion in the second and the fourth sector. The second outer radius is greater than the first outer radius.

In the case of the stator laminated core according to the invention, the outer radius of the lateral surface along one axial portion is greater in two of the sectors than in the other two sectors, in order that these sectors can centre the stator laminated core inside a stator housing. If, for example, the stator laminated core is inserted into the stator housing with the second end face in front, it can move axially in the stator housing until the axial portion is reached. Then, by virtue of the greater outer radius in the second sector and in the fourth sector, contact which centres the stator laminated core in the stator housing can be formed with the correspondingly formed stator housing. This enables a precise arrangement of the stator laminated core in the stator housing, as a result of which in particular it is possible to reduce vibrations during operation that result from a large deviation of the positions of the longitudinal axes of the stator laminated core and the stator housing in relation to one another.

It is also possible for slots, which extend from the first end face to the second end face and are circumferentially distributed about the longitudinal axis, to be formed in the stator laminated core. In the case of the stator laminated core according to the invention, in particular first to fourth fastening openings arranged outside the sectors are provided. It is also possible to provide fifth to (2·i)th fastening openings and fifth to (2·i)th non-overlapping sectors, wherein i is a natural number greater than or equal to three. In that case, the radially outer lateral surface can have the first outer radius along the axial portion in the odd-designated sectors and the second outer radius in the even-designated sectors.

In a preferred refinement, the stator laminated core according to the invention has a second axial portion which extends from the second end face towards the first end face and does not overlap the first axial portion. The first axial portion and the second axial portion may comprise the entire axial extent of the stator laminated core. It is also possible to provide that the radially outer lateral surface along the second axial portion has the second outer radius in the first and the third sector and the first outer radius in the second and the fourth sector.

It is also advantageous if the axial extent of the first axial portion is at most one quarter, in particular at most one ninth, of the axial extent of the second axial portion. Such a short design of the second axial portion means the stator laminated core only needs to be guided over a short section along the second radius when being inserted into the stator device, as a result of which undesirable chip formation is reduced and good centring, as it were, is achieved.

The stator laminated core may be formed of a multiplicity of individual laminations which are layered along the longitudinal axis and each have a central hole, a number of outer holes corresponding to the number of fastening openings, and an outer periphery, wherein the central holes are arranged congruently in relation to one another such that they form the rotor receiving space, and the outer holes are arranged congruently in relation to one another such that they form the fastening openings. In a preferred configuration, it is also provided that the outer periphery at least partially has the first outer radius and at least partially has the second outer radius, wherein the individual laminations along the first axial portion are arranged such that the outer periphery forms the first outer radius of the outer lateral surface in the first and the third sector and the second outer radius of the outer lateral surface in the second and the fourth sector. It is also preferably provided that the individual laminations along the second axial portion are arranged rotated about the longitudinal axis with respect to the individual laminations in the first axial portion such that the outer periphery forms the first outer radius of the outer lateral surface in the second and the fourth sector and the second outer radius of the outer lateral surface in the first and the third sector. To form the laminated core with the outer radii which are different in the sectors, it is possible to use individual laminations that are formed similarly in this way and are rotated in relation to one another by a predetermined angle of for example 90°. This advantageously reduces the variety of parts for the production of the stator laminated core. The individual laminations are preferably electrically insulated from one another.

In particular, the stator laminated core according to the invention is arranged mirror-symmetrically with respect to a plane of symmetry which divides the first sector in half and/or with respect to a plane of symmetry which divides one of the even-designated sectors, in particular the second sector or the fourth sector, in half.

In the case of the stator laminated core according to the invention, it is also provided that the curve of the outer circumference of the outer lateral surface between two respective circumferentially adjacent sectors about a respective angular position at which one of the fastening openings is located is greater than the first outer radius, and the fastening openings are each at least partially outside the first outer radius. The outer lateral surface may accordingly be provided with radial bulges in which—completely or partially—the fastening openings are formed. This provides enough radial space even for relatively large fastening openings or fastening means without influencing an inner radial region of the stator core in which, for example, the slots for the stator winding are formed. In particular, angular regions comprising the angular positions in which the curve of the outer circumference is greater than the first outer radius do not belong to the sectors.

The object on which the invention is based is also achieved by a stator device comprising a stator laminated core according to the invention; a stator housing having a longitudinal axis corresponding to the longitudinal axis of the stator laminated core, wherein the stator housing has a radially inner lateral surface which delimits a stator receiving space, and the stator laminated core is accommodated in the stator receiving space in such a way that the inner lateral surface faces towards the outer lateral surface of the stator laminated core, wherein the inner lateral surface has an inner radius, which forms a press fit with the outer lateral surface, in a region in which it faces towards the second and the fourth sector along the first axial portion and has an inner radius, which forms a radial gap in relation to the outer lateral surface, in a region in which it faces towards the first and the third sector in the first axial portion; and fastening elements, which pass through the fastening openings and brace the stator laminated core against the stator housing.

In an advantageous refinement of the stator device, it may be provided that the inner lateral surface has an inner radius, which forms a press fit with the outer lateral surface, in a region in which it faces toward the first and the third sector along a sub-portion of the second axial portion that extends from the second end face towards the first end face and has an inner radius, which forms a radial gap in relation to the outer lateral surface, in a region in which it faces towards the second and the fourth sector along the sub-portion. This also makes it possible to achieve centring with respect to the second end face of the stator laminated core in the stator housing.

To avoid undesirable chip formation, it is also possible to provide here that the axial extent of the sub-portion is at most one quarter, in particular at most one ninth, of the axial extent of the second axial portion.

The inner lateral surface may also have an inner radius, which forms a radial gap in relation to the outer lateral surface, in a region in which it faces towards the first to the fourth sector along a second sub-portion which extends from the first sub-portion to the first axial portion. The inner radius of the inner lateral surface is preferably constant in its region facing towards the second and the fourth sector.

The stator device according to the invention may also have a cooler which is configured to convey a cooling fluid through a cooling channel to cool the stator device. The cooling channel is preferably at least partially formed by the or a respective gap. The cooling fluid may be liquid, for example water, oil or a coolant, or gaseous.

It may also be provided that the stator housing forms an end shield and the second end face faces towards the end shield.

The object on which the invention is based is also achieved by a method for producing a stator device, comprising the following steps: providing a stator laminated core according to the invention; providing a stator housing having a longitudinal axis corresponding to the longitudinal axis of the stator laminated core, wherein the stator housing has a radially inner lateral surface which delimits a stator receiving space; inserting the stator laminated core into the stator receiving space so that the radially inner lateral surface faces towards the outer lateral surface of the stator laminated core, wherein the inner lateral surface has an inner radius, which upon insertion forms a press fit with the outer lateral surface, in a region in which it faces towards the second and the fourth sector along the first axial portion and has an inner radius, which upon insertion forms a radial gap in relation to the outer lateral surface, in a region in which it faces towards the first and the third sector in the first axial portion; and bracing the stator laminated core against the stator housing by means of fastening elements, which pass through the fastening openings.

The stator may comprise a wire-wound winding received in the stator core.

The stator may comprise a shaped-conductor winding received in the stator core. The shaped conductors may have a polygonal cross section and the form of a U-pin or I-pin. A U-pin is formed in one piece and has two conductor arms which can be received in different slots of the stator core. The shaped conductors can be connected to adjacent, further shaped conductors at their free ends, which protrude from an end face of the stator core. On the other end face, they are connected to one another in pairs and in one piece. An I-pin has two free ends which protrude from the slot on oppositely situated end faces of the stator core and can be connected to free ends of adjacent shaped conductors.

All of the explanations relating to the stator laminated core according to the invention and to the stator device according to the invention can be applied analogously to the method according to the invention, such that the advantages described above can also be achieved with it.

The object on which the invention is based is also achieved by an electric machine for an electrically drivable vehicle, comprising a stator device according to the invention or a stator device obtained by the method according to the invention, and a rotor rotatably mounted inside the rotor receiving space, wherein the electric machine is configured to drive the vehicle.

The object on which the invention is based is also achieved by an electrically drivable vehicle comprising an electric machine according to the invention.

Further advantages and details of the present invention emerge from the drawings described below. They are schematic illustrations in which:

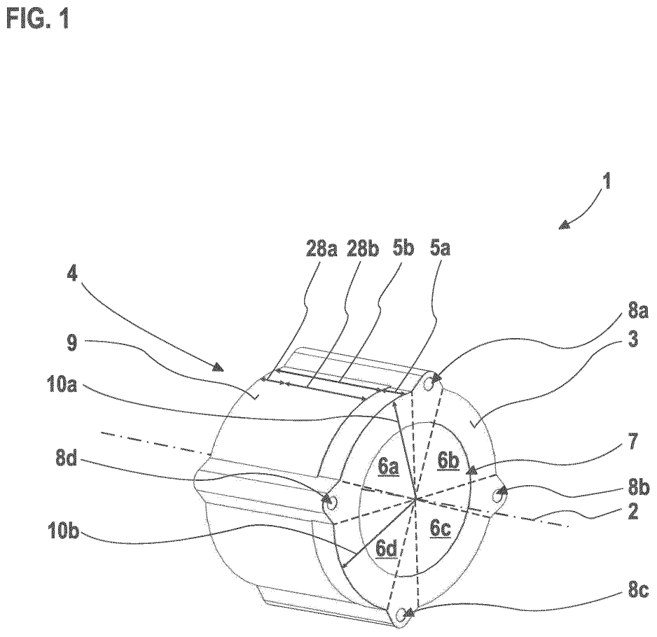

FIG. 1 shows a perspective view of an exemplary embodiment of the stator laminated core according to the invention;

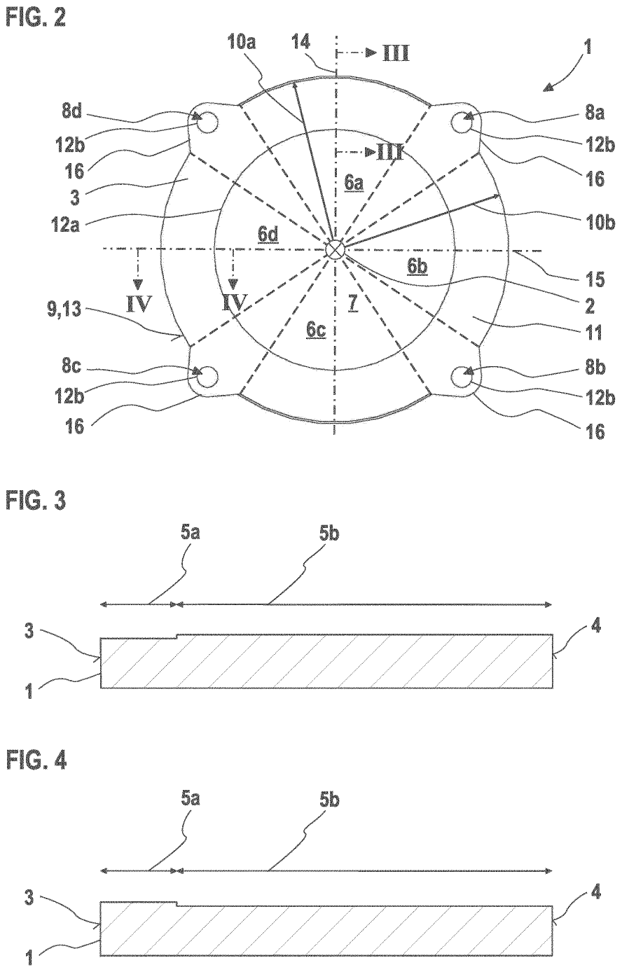

FIG. 2 shows a plan view of the first end face of the stator laminated core according to the exemplary embodiment;

FIG. 3 shows a sectional illustration of the stator laminated core according to the exemplary embodiment along a sectional plane III-III in FIG. 2;

FIG. 4 shows a sectional illustration of the stator laminated core according to the exemplary embodiment along a sectional plane IV-IV in FIG. 2;

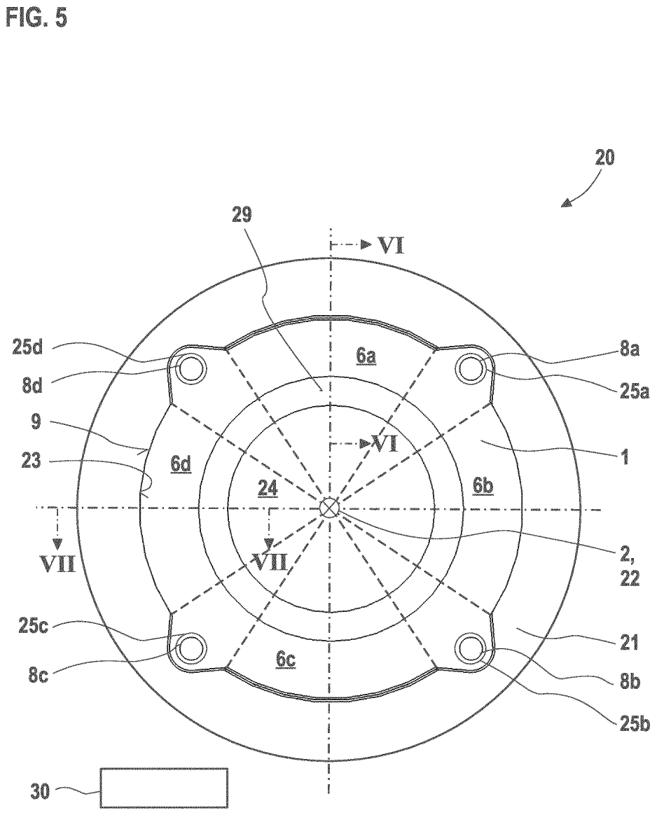

FIG. 5 shows a plan view of the end face of an exemplary embodiment of the stator device according to the invention;

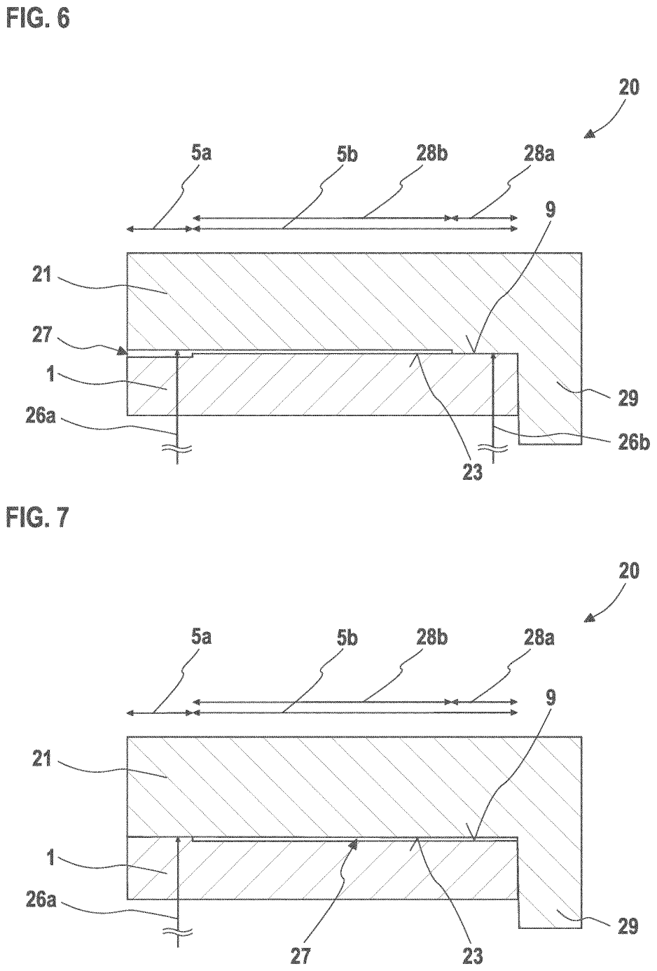

FIG. 6 shows a sectional illustration of the stator device according to the exemplary embodiment along a sectional plane VI-VI in FIG. 5;

FIG. 7 shows a sectional illustration of the stator device according to the exemplary embodiment along a sectional plane VII-VII in FIG. 5;

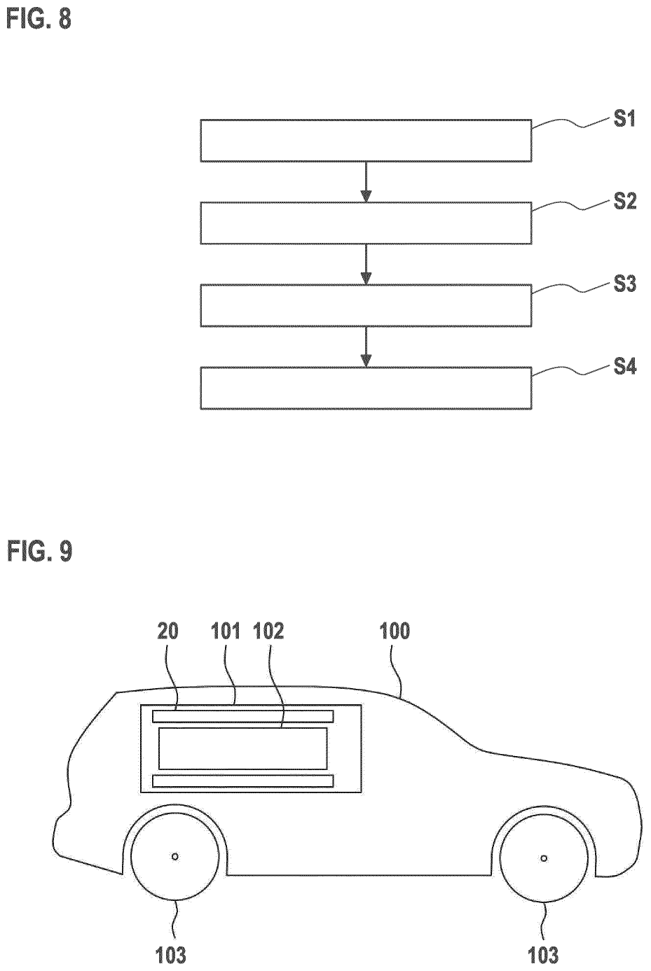

FIG. 8 shows a flow diagram of an exemplary embodiment of a production method according to the invention; and

FIG. 9 shows a basic diagram of an exemplary embodiment of the electrically drivable vehicle according to the invention, comprising an exemplary embodiment of the electric machine according to the invention.

FIG. 1 is a perspective view of an exemplary embodiment of a stator laminated core 1.

The stator laminated core 1 has a longitudinal axis 2, a first end face 3 and a second end face 4, which is situated axially opposite the first end face 3. The stator laminated core 1 is axially subdivided into a first axial portion 5a extending from the first end face 3 towards the second end face 4 and a second axial portion 5b extending from the second end face 4 towards the first end face 3, the axial portions comprising the entire axial extent of the stator laminated core 1 without overlap in the present exemplary embodiment. The axial extent of the first axial portion 5a is approximately one fifth of the axial extent of the second axial portion 5b. Moreover, the stator laminated core 1 is circumferentially subdivided into non-overlapping first to fourth sectors 6a to 6d, which are distributed circumferentially in the order of their designation.

The stator laminated core 1 forms a rotor receiving space 7, which extends along the longitudinal axis 2 from the first end face 3 to the second end face 4. Fastening openings 8a to 8d are also distributed about the longitudinal axis 3 at angular positions between two adjacent ones of the first to fourth sectors 6a to 6d, that is between the first sector 6a and the second sector 6b, between the second sector 6b and the third sector 6c, between the third sector 6cand the fourth sector 6d, and between the fourth sector 6dand the first sector 6a. The fastening openings 8a to 8d extend from the first end face 3 to the second end face 4.

The stator laminated core 1 also has a radially outer lateral surface 9. Along the first axial portion 5a, the outer lateral surface 9 has a first outer radius 10a in the first sector 6a and in the third sector 6c and has a second outer radius 10b, which is greater than the first outer radius 10a, in the second sector 6b and in the fourth sector 6d. Along the second axial portion 5b, the outer lateral surface 9 also has the second outer radius 10b in the first sector 6a and in the third sector 6c and the first outer radius 10a in the second sector 6b and in the fourth sector 6d.

Furthermore, the stator laminated core 1 forms a multiplicity of slots, which are distributed circumferentially, point towards the rotor receiving space 7, are intended for receiving a stator winding, and are not illustrated in the figures for the sake of clarity.

FIG. 2 is a plan view of the first end face 3 of the stator laminated core 1 according to the exemplary embodiment. FIG. 3 and FIG. 4 show the stator laminated core 1 according to the exemplary embodiment, with FIG. 3 being a sectional illustration along a sectional plane III-III in FIG. 2 and FIG. 4 being a sectional illustration along a sectional plane IV-IV in FIG. 2.

The stator laminated core 1 is formed of a multiplicity of individual laminations 11, which are layered along the longitudinal axis 2 and only the axially outermost one of which can be seen in full in FIG. 2. Each individual lamination 11 has a central hole 12a, a number of outer holes 12b corresponding to the number of fastening openings 8a to 8d, and an outer periphery 13, which at least partially has the first outer radius 10a and at least partially has the second outer radius 10b.

The central holes 12a in the individual laminations 11 are arranged congruently in relation to one another such that they form the rotor receiving space 7. The outer holes 12b are arranged congruently in relation to one another such that they form the fastening openings 8a to 8d. The individual laminations 11 are arranged along the first axial portion 5a (see FIG. 1) such that the outer periphery 13 forms the first outer radius 10a of the outer lateral surface 9 in the first sector 6a and in the third sector 6c and the second outer radius 10b of the outer lateral surface 9 in the second sector 6b and in the fourth sector 6d. Along the second axial portion 5b, the individual laminations 11 are arranged rotated about the longitudinal axis 2 with respect to the individual laminations 11 in the first axial portion 5a such that the outer periphery 13 forms the first outer radius 10a of the outer lateral surface 9 in the second sector 6b and in the fourth sector 6d and the second outer radius 10b of the outer lateral surface 9 in the first sector 6a and in the third sector 6c.

In this way, the stator laminated core 1 can be formed by individual sheets 11 of a single shape. The individual laminations 11 are moreover mirror-symmetrical with respect to a plane of symmetry 14 which divides the first sector 6a in half and with respect to a plane of symmetry 15 which divides one of the second sectors 6b in half.

It can also be seen in FIG. 2 that the curve of the outer circumference of the outer lateral surface 9 between two respective circumferentially adjacent sectors 6a to 6d about a respective angular position at which one of the fastening openings 8a to 8d is located is greater than the first outer radius 10a, and the fastening openings 8a to 8d are each at least partially outside the first outer radius 10a. This forms radial-figuratively speaking, ear-shaped-bulges 16 of the stator core 1.

FIG. 5 is a plan view of the end face of an exemplary embodiment of a stator device 20. FIG. 6 and FIG. 7 show the stator device 20 according to the exemplary embodiment, with FIG. 6 being a sectional illustration along a sectional plane VI-VI in FIG. 5 and FIG. 7 being a sectional illustration along a sectional plane VII-VII in FIG. 5.

The stator device 20 comprises the stator laminated core 1 according to the exemplary embodiment described above and a stator housing 21. The stator housing 21 has a longitudinal axis 22, which corresponds to the longitudinal axis 2 of the stator laminated core 1, and has a radially inner lateral surface 23, which delimits a stator receiving space 24. The stator laminated core 1 is accommodated in the stator receiving space 24 such that the inner lateral surface 23 faces towards the outer lateral surface 9 of the stator laminated core 1.

In addition, the stator device 20 comprises fastening elements 25a to 25d, which pass through the fastening openings 8a to 8d and brace the stator laminated core 1 against the stator housing 21. Here, the fastening elements 25a to 25d are in the form of screws or threaded bolts and schematically illustrated by way of their head.

The inner lateral surface 23 has a first inner radius 26a, which forms a press fit with the outer lateral surface 9, in a region in which it faces towards the second sector 6b and the fourth sector 6d along the first axial portion 5a. The inner lateral surface 23 also likewise has the first inner radius 26a, which forms a radial gap 27 in relation to the outer lateral surface 9, in a region in which it faces towards the first sector 6a and the third sector 6c in the first axial portion 5a.

The second axial portion 5b is subdivided into a first sub-portion 28a, which extends from the second end face 4 towards the first end face 3, and a second sub-portion 28b. The axial extent of the first sub-portion 28a is approximately one fifth of the axial extent of the second axial portion 5b. In a region in which the inner lateral surface 23 faces towards the first sector 6a and the third sector 6c along the first sub-portion 28a of the second axial portion 5b, the inner lateral surface 23 has a second inner radius 26b, which forms a press fit with the outer lateral surface 9. In a region in which the inner lateral surface 9 faces towards the second sector 6b and the fourth sector 6d along the first sub-portion 28a, the inner lateral surface has the first inner radius 26a, which forms the radial gap 27 in relation to the outer lateral surface 9. The inner lateral surface 23 also has the first inner radius 26a, which forms the radial gap 27 in relation to the outer lateral surface 9, in a region in which it faces towards the first to the fourth sector 6a to 6d along the second sub-portion 28b.

As can also be seen in FIG. 5 to FIG. 7, the stator housing 21 forms an end shield 29 facing towards the second end face 4. FIG. 5 also purely schematically shows a cooler 30 of the stator device 20. The cooler 30 is configured to convey a cooling fluid through the cooling channel to cool the stator device 20. The cooling channel is at least partially formed by the gap 27. The cooling fluid may be liquid, for example water, oil or a coolant, or gaseous.

FIG. 8 is a flow diagram of an exemplary embodiment of a method for producing the stator device 20. To explain the method, reference is made to the preceding exemplary embodiments.

The production method comprises a step S1 of providing the stator laminated core 1 according to the exemplary embodiment. The stator housing 21 is provided in a step S2.

In a subsequent step S 3, the stator laminated core 1 is inserted into the stator receiving space 24 so that the radially inner lateral surface 23 faces towards the outer lateral surface 9 of the stator laminated core 1, wherein the inner lateral surface 23 has the inner radius 26a, which upon insertion forms a press fit with the outer lateral surface 9, in that region in which it faces towards the second sector 6b and the fourth sector 6d along the first axial portion 5a and has the inner radius 26a, which upon insertion forms the radial gap 27 in relation to the outer lateral surface 9, in that region in which the outer lateral surface faces towards the first sector 6a and the third sector 6c along the first axial portion 5a.

In a subsequent step S4, the stator laminated core 1 is braced against the stator housing 21 by the fastening elements 25a to 25d that pass through the fastening openings 8a to 8d.

According to further exemplary embodiments, the first axial portion 5a and/or the first sub-portion 28a may also extend only over one ninth of the axial extent of the second axial portion 8b.

FIG. 9 is a schematic diagram of an exemplary embodiment of an electrically drivable vehicle 100 comprising an exemplary embodiment of an electric machine 101.

The electric machine 101, for example a permanently or electrically excited synchronous motor or an asynchronous motor, comprises the stator device 20 according to the exemplary embodiment described above or a stator device 20 obtained by an exemplary embodiment of the method and a rotor 102. The rotor 102 is mounted rotatably with respect to the stator laminated core 1 of the stator device 20.

The vehicle 100 furthermore has wheels 103. The electric machine 101 is configured to drive at least one of the wheels 103 indirectly, for example via a gear mechanism (not shown), or directly, for example in the form of a wheel hub motor. The vehicle 100 can also have an axle (not shown) which is coupled to the wheel 103 and which directly or indirectly drives the electric machine 101 of the vehicle 100.

The vehicle 100 according to the invention is a battery electric vehicle (BEV), a vehicle operated by means of a fuel cell, or a hybrid vehicle. In the latter case, the vehicle 100 also has an internal combustion engine (not shown).

1. Stator laminated core having a longitudinal axis, having a first end face, having a second end face situated axially opposite the first end face, having a first axial portion extending from the first end face towards the second end face, and having first to fourth non-overlapping sectors distributed circumferentially in the order of their designation, wherein the stator laminated core
forms a rotor receiving space which extends along the longitudinal axis from the first end face to the second end face,
forms multiple fastening openings, which are distributed about the longitudinal axis at angular positions between two adjacent ones of the first to fourth sectors and extend from the first end face to the second end face, and
has a radially outer lateral surface, which has a first outer radius along the first axial portion in the first and the third sector and has a second outer radius, which is greater than the first outer radius, along the first axial portion in the second and the fourth sector.

2. Stator laminated core according to claim 1, having
a second axial portion which extends from the second end face towards the first end face and does not overlap the first axial portion, wherein the radially outer lateral surface along the second axial portion has the second outer radius in the first and the third sector and the first outer radius in the second and the fourth sector.

3. Stator laminated core according to claim 2, wherein the axial extent of the first axial portion is at most one quarter, in particular at most one ninth, of the axial extent of the second axial portion.

4. Stator laminated core according to claim 2, which
is formed of a multiplicity of individual laminations which are layered along the longitudinal axis and each have a central hole, a number of outer holes corresponding to the number of fastening openings, and an outer periphery, wherein the central holes are arranged congruently in relation to one another such that they form the rotor receiving space, and the outer holes are arranged congruently in relation to one another such that they form the fastening openings, wherein the outer periphery at least partially has the first outer radius and at least partially has the second outer radius, wherein the individual laminations along the first axial portion are arranged such that the outer periphery forms the first outer radius of the outer lateral surface in the first and the third sector and the second outer radius of the outer lateral surface in the second and the fourth sector wherein the individual laminations along the second axial portion are arranged rotated about the longitudinal axis with respect to the individual laminations in the first axial portion such that the outer periphery forms the first outer radius of the outer lateral surface in the second and the fourth sector and the second outer radius of the outer lateral surface in the first and the third sector.

5. Stator laminated core according to claim 1, which is arranged mirror-symmetrically with respect to a plane of symmetry which divides the first sector in half and/or with respect to a plane of symmetry which divides one of the even-designated sectors in half.

6. Stator laminated core according to claim 1, wherein
the curve of the outer circumference of the outer lateral surface between two respective circumferentially adjacent sectors about a respective angular position at which one of the fastening openings is located is greater than the first outer radius, and the fastening openings are each at least partially outside the first outer radius.

7. Stator device comprising
a stator laminated core according to claim 2;
a stator housing having a longitudinal axis corresponding to the longitudinal axis of the stator laminated core, wherein the stator housing has a radially inner lateral surface which delimits a stator receiving space, and the stator laminated core is accommodated in the stator receiving space in such a way that the inner lateral surface faces towards the outer lateral surface of the stator laminated core, wherein the inner lateral surface has an inner radius, which forms a press fit with the outer lateral surface, in a region in which it faces towards the second and the fourth sector along the first axial portion and has an inner radius, which forms a radial gap in relation to the outer lateral surface, in a region in which it faces towards the first and the third sector in the first axial portion; and
fastening elements, which pass through the fastening openings and brace the stator laminated core against the stator housing.

8. Stator device according to claim 7, wherein
the inner lateral surface has an inner radius, which forms a press fit with the outer lateral surface, in a region in which it faces toward the first and the third sector along a sub-portion of the second axial portion that extends from the second end face towards the first end face and has an inner radius which forms a radial gap in relation to the outer lateral surface, in a region in which it faces towards the second and the fourth sector along the sub-portion.

9. Stator device according to claim 8, wherein
an axial extent of the sub-portion is at most one quarter, in particular at most one ninth, of the axial extent of the second axial portion.

10. Stator device according to claim 8, wherein
the inner lateral surface has an inner radius, which forms a radial gap in relation to the outer lateral surface, in a region in which it faces towards the first to the fourth sector along a second sub-portion which extends from the first sub-portion to the first axial portion.

11. Stator device according to claim 7, wherein
the inner radius of the inner lateral surface is constant in its region facing towards the second and the fourth sector.

12. Stator device according to claim 7, wherein
the stator housing forms an end shield and the second end face faces towards the end shield.

13. Method for producing a stator device, comprising the following steps:
providing a stator laminated core according to claim 1;
providing a stator housing having a longitudinal axis corresponding to the longitudinal axis of the stator laminated core, wherein the stator housing has a radially inner lateral surface which delimits a stator receiving space;
inserting the stator laminated core into the stator receiving space so that the radially inner lateral surface faces towards the outer lateral surface of the stator laminated core, wherein the inner lateral surface has an inner radius, which upon insertion forms a press fit with the outer lateral surface, in a region in which it faces towards the second and the fourth sector along the first axial portion and has an inner radius, which upon insertion forms a radial gap in relation to the outer lateral surface, in a region in which it faces towards the first and the third sector in the first axial portion; and
bracing the stator laminated core against the stator housing by means of fastening elements which pass through the fastening openings.

14. Electric machine for an electrically drivable vehicle , comprising a stator device according to claim 7, and a rotor rotatably mounted inside the rotor receiving space, wherein the electric machine is configured to drive the vehicle.

15. Electrically drivable vehicle comprising an electric machine according to claim 14.

16. Stator laminated core according to claim 3, which
is formed of a multiplicity of individual laminations, which are layered along the longitudinal axis and each have a central hole, a number of outer holes corresponding to the number of fastening openings, and an outer periphery, wherein the central holes are arranged congruently in relation to one another such that they form the rotor receiving space, and the outer holes are arranged congruently in relation to one another such that they form the fastening openings, wherein the outer periphery at least partially has the first outer radius and at least partially has the second outer radius, wherein the individual laminations along the first axial portion are arranged such that the outer periphery forms the first outer radius of the outer lateral surface in the first and the third sector and the second outer radius of the outer lateral surface in the second and the fourth sector, wherein the individual laminations along the second axial portion are arranged rotated about the longitudinal axis with respect to the individual laminations in the first axial portion such that the outer periphery forms the first outer radius of the outer lateral surface in the second and the fourth sector and the second outer radius of the outer lateral surface in the first and the third sector.

17. Stator laminated core according to claim 2, which
is arranged mirror-symmetrically with respect to a plane of symmetry which divides the first sector in half and/or with respect to a plane of symmetry which divides one of the even-designated sectors in half.

18. Stator laminated core according to claim 2, wherein
the curve of the outer circumference of the outer lateral surface between two respective circumferentially adjacent sectors about a respective angular position at which one of the fastening openings is located is greater than the first outer radius, and the fastening openings are each at least partially outside the first outer radius.

19. Stator device comprising
a stator laminated core according to claim 2;
a stator housing having a longitudinal axis corresponding to the longitudinal axis of the stator laminated core, wherein the stator housing has a radially inner lateral surface which delimits a stator receiving space, and the stator laminated core is accommodated in the stator receiving space in such a way that the inner lateral surface faces towards the outer lateral surface of the stator laminated core, wherein the inner lateral surface has an inner radius, which forms a press fit with the outer lateral surface, in a region in which it faces towards the second and the fourth sector along the first axial portion and has an inner radius, which forms a radial gap in relation to the outer lateral surface, in a region in which it faces towards the first and the third sector in the first axial portion; and
fastening elements, which pass through the fastening openings and brace the stator laminated core against the stator housing.

20. Stator device according to claim 9, wherein
the inner lateral surface has an inner radius, which forms a radial gap in relation to the outer lateral surface, in a region in which it faces towards the first to the fourth sector along a second sub-portion which extends from the first sub-portion to the first axial portion.
